(19) United States
(12) Patent Application Publication
(10) Pub. No.: US 2004/0129489 A1
(43) Pub. Date: Jul. 8, 2004

(54) Sand rail vehicle

(76) Inventors: Glenn Brasseal, Harlan, IN (US); Bob Heckman, Harlan, IN (US)

Correspondence Address: RANDALL J. KNUTH P.C., 3510-A STELLHORN ROAD, FORT WAYNE, IN, 46815-4631, US

(21) Appl. No.: 10/673,628

(22) Filed: Sep. 26, 2003

Related U.S. Application Data
(60) Provisional application No. 60/413,975, filed on Sep. 26, 2002.

(51) Int. Cl. B60K 17/00

(52) U.S. Cl. 180/350

(57) ABSTRACT

The sand rail/dune buggy includes a roll-cage frame, a four-wheel independent suspension system, and a compact, rear-mounted drive chain system. The roll-cage frame is supplied with a quick-release, spring-loaded slam hatch to permit easy ingress and egress. The slam hatch carries a steering wheel which is part of a rack-and-pinion steering system for the vehicle. Each of the wheels is independently and adjustably suspended, thereby contributing to both the ride stability of the vehicle and the ability thereof to accommodate various use conditions. The drive system includes (in a generally top to bottom fashion) an engine, an input drive shaft with an associated reverser mechanism, and an output drive shaft. The output drive shaft features an output differential and separate swing-arm drives and disk brakes for each of the rear wheels, allowing separate motion control of such wheels.

### PRIORITY INFORMATION

This application hereby claims the benefit under Title 35, United States Codes § 119(e) of any U.S. application serial No. 60/413,975 filed on Sep. 26, 2002, and is hereby incorporated by reference.

### BACKGROUND OF THE INVENTION

1. Field of the Invention

The present invention relates to a sand rail/dune buggy, and more particularly to a sand rail having four-wheel independent suspension and that is further designed both for compactness and safety.

2. Description of the Related Art

A variety of compact off-road vehicles such as go-carts sand rails, and dune buggies have been available for recreational use for several years. Vehicles of the types listed generally have a rigid chassis to which four wheels are connected and are generally constructed to promote their durability. Additionally, such a vehicle is often provided with a suspension system which promotes better handling and a smoother ride, even over rough terrain.

However, such compact vehicles tend to have their limitations with respect to their balance, control, and ability to clear obstacles. A limiting factor with such compact vehicles that can limit all three of those capabilities is the reliance on the use of a shaft interconnecting the back wheels. Such a shaft can act as an obstruction to objects between the wheels over which the vehicle is attempting to pass. Additionally, when wheels are interconnected by an axle, a variation in terrain height between being traversed by the left and right wheels connected thereby will inherently contribute to an imbalance (i.e., tipping) in the vehicle.

Additionally, the known compact off-road vehicles that have been available generally have relatively complex drive systems that have tended to contributed to an increased size of the vehicle. Such increased size adversely affects the maneuverability of the vehicle and the ease of transportation thereof. Furthermore, such vehicles have tended to rely on a complicated gearing system in order to achieve a potential for a reverse gear.

A constant concern with such compact vehicles is their ability to maintain the safety of the driver. Due to the layout of the body of such vehicles, in the past there has been a concern with the ability of such vehicles to avoid and/or withstand rolling. In an attempt to address this problem, many such compact vehicles now provide for some type of roll bar or roll cage to help protect the driver. Such features still do not necessarily address the ability of such vehicles to avoid rolling in the first place and/or the ability to sufficiently protect the driver while still allowing easy entrance/exit from the vehicle.

What is needed in the art is a sand rail/dune buggy that will have improved safety and handling features and provide a drive system that is both more compact and easier to operate.

### SUMMARY OF THE INVENTION

The present invention relates to a sand rail/dune buggy that provides four-wheel independent suspension and that is further designed for compactness to facilitate both maneuverability and handling during use and transportation thereof when not used.

One advantage of the present is invention is that it has a four-wheel independent suspension which provides a significant amount of vertical travel for each of the wheels to thereby allow a variety of terrains to be traversed while permitting the sand rail to maintain its overall balance.

Another advantage of the present invention is that the frame design and the relatively vertical placement of the components of the drive system at the rear of the vehicle allow the sand rail to be compact, thereby permitting it to be transported in the back of the pick-up truck.

Yet another advantage of the present invention is that braking is performed on the differential/drive shaft instead of the wheels, thereby promoting greater control over braking.

Still another advantage of the present invention is that no drive shaft is needed to connect the back wheels, thereby providing greater clearance over potential hazards.

Another advantage of the present invention is that a simple reverse system is provided that avoids the need for a complicated gearing system to achieve such reverse and potentially allows the sand rail to be driven as fast in reverse as forward.

Yet another advantage of the present invention is that potential separate rear braking for each wheel is available to facilitate quick turns.

A further advantage is that the gas tank may be designed based upon an air tank to thereby be inexpensive, pressure resistant, and durable.

An even further advantage of the present invention is that the frame creates a roll cage that further protects the driver and the drive train system, as well as any lights and any other parts associated with the sand rail, while still permitting an easy entrance/exit via a slam hatch.

Another advantage of the present invention is that the suspension systems are convertible so as to optimize the sand rail for a range of uses including track racing and off-road use.

An additional advantage of the present invention is that the sand rail is relatively light at about 435 pounds and can achieve speeds in the range of 85 to 130 mph, depending on the motor used.

A further advantage of the present invention is that the sand rail can accommodate a person who weighs in the range of 150 to 300 pounds.

Another advantage of the present invention is that the combination of the frame structure and the suspension system make the sand rail very stable, smooth riding, and difficult to roll.

Still another advantage of the present invention is that the ability to relatively place the input and output drive shafts near the back of the driver's seat contributes to the compactness of the vehicle.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a front perspective view of the sand rail/dune buggy of the present invention;

FIG. 2 is a side view of the sand rail shown in FIG. 1;

FIG. 3 is a top perspective view of the sand rail shown in FIG. 1;

FIG. 4 is a partial, top perspective view of the sand rail of FIG. 1, featuring the slam hatch of the present invention;

FIG. 5 is a partial side view of the sand rail shown in FIG. 1, directed to the rear drive chain and suspension system;

FIG. 6 is a perspective view of the input and output drive shafts in the drive chain system of the sand rail shown in FIG. 1;

FIG. 7 is a top, perspective view of the front end of the sand rail shown in FIG. 1;

FIG. 8 is a rear, perspective view of the sand rail illustrated in FIG. 1; and

FIG. 9 is a partial rear view of the sand rail shown in FIG. 1, featuring the drive chain connection of a rear wheel to the rest of the vehicle.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

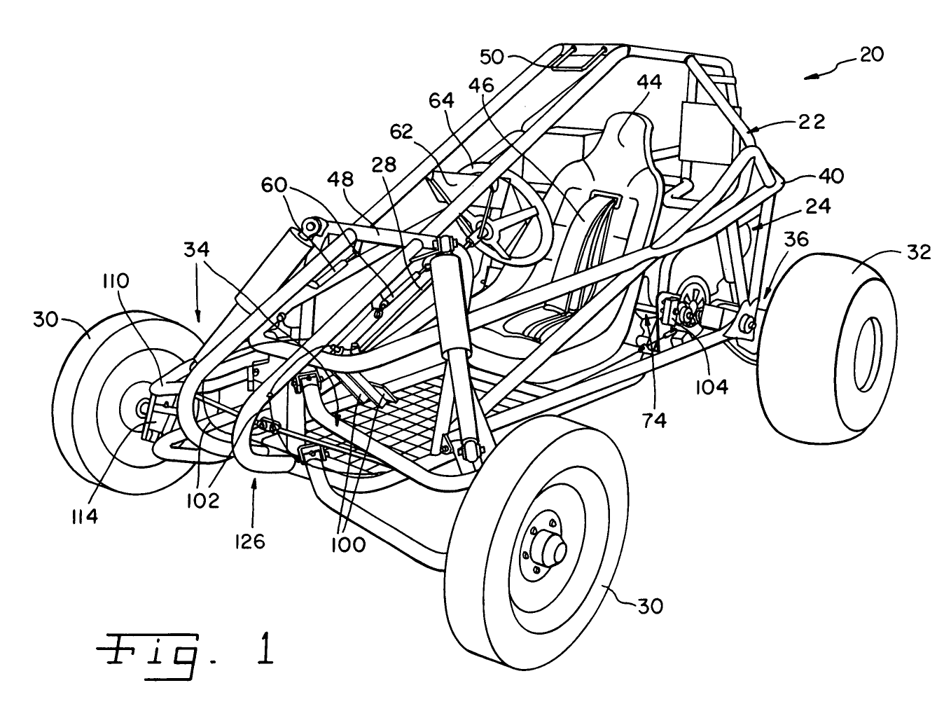

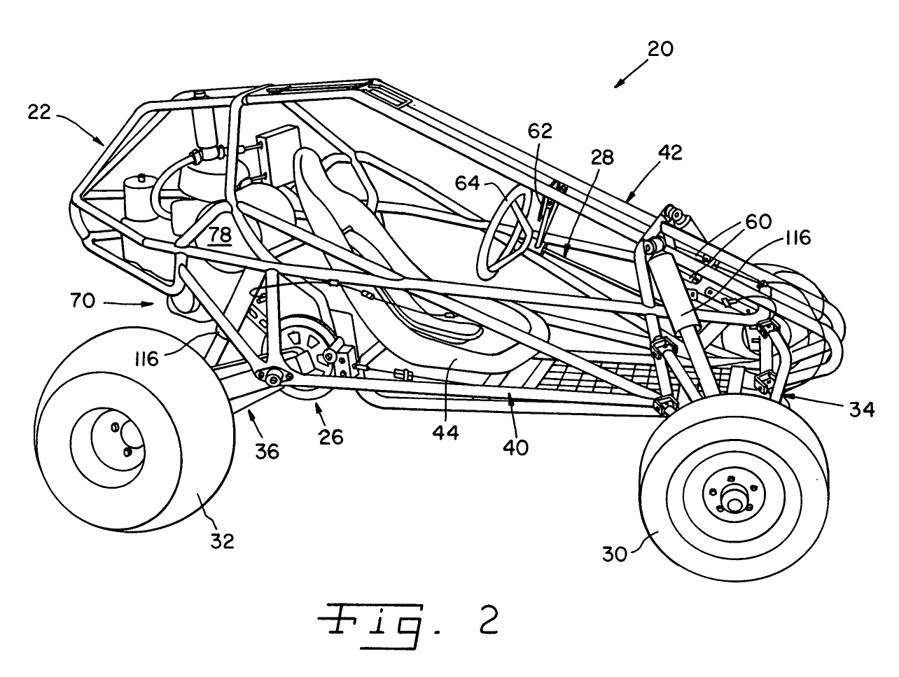

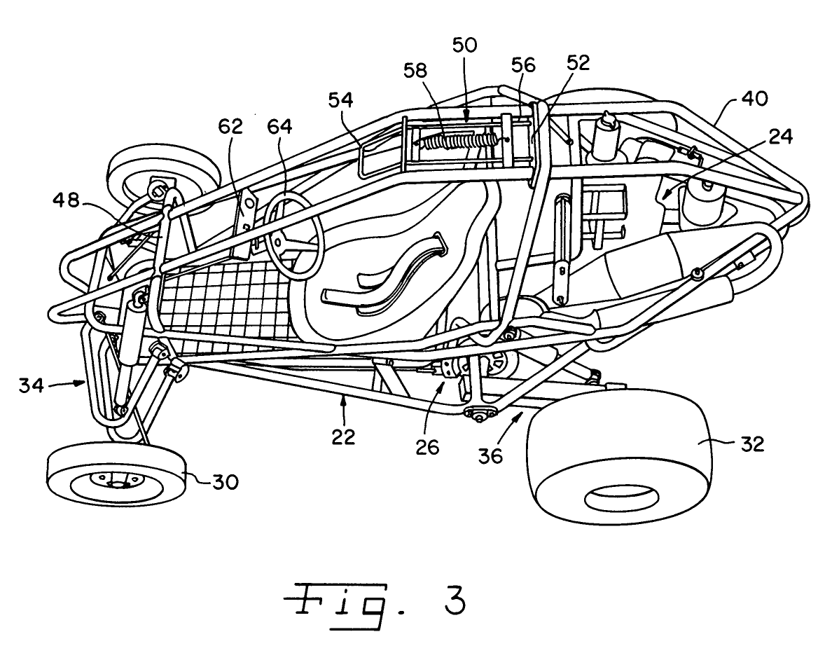

The present invention relates to a sand rail 20, which is also commonly referred to as a dune buggy. Sand rail 20 includes a frame 22, a drive train system 24, a brake system 26, a rack-and-pinion steering system 28, front wheels 30, rear wheels 32, A-frame front suspension systems 34, and swing-arm rear suspension systems 36, as seen in FIGS. 1-3.

Frame 22 includes a main frame portion 40 and a slam hatch 42. Frame 22 acts as a full roll cage for drive train system 24 and driver seat 44, among others as visible from FIGS. 1-3. Driver seat 44 is supplied with a five-point racing harness 46 as a standard safety measure.

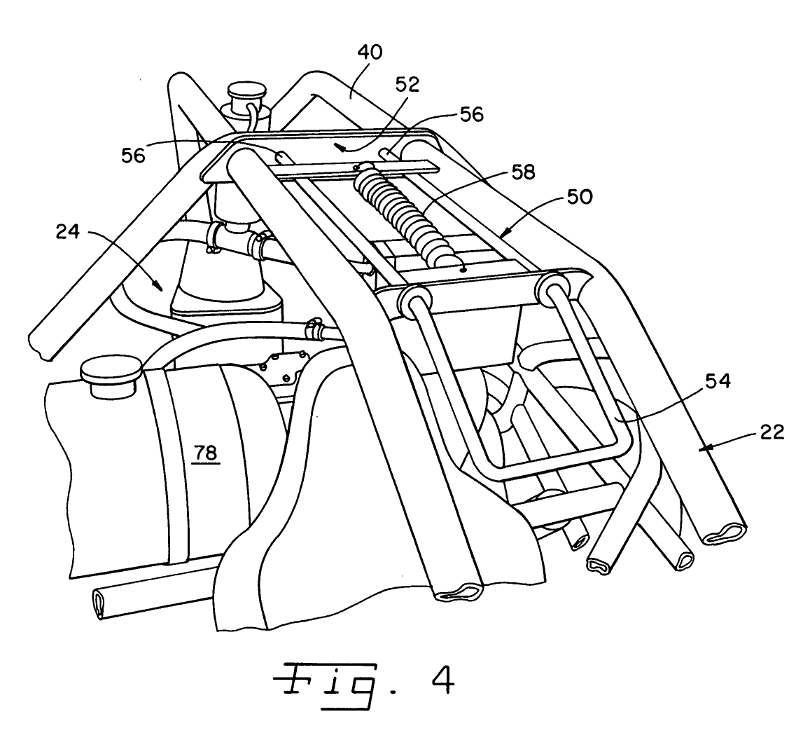

Slam hatch 42 is pivotally mounted upon frame cross member 48 at a position forward of driver seat 44. Slam hatch 42 is releasably connected to main frame portion 40 via a hatch release mechanism 50 located above driver seat 44. Hatch release mechanism 50, as best seen in FIG. 4, is a quick release mechanism that engages a catch/striker plate 52 associated with main frame portion 40 when in the shut position. Hatch release mechanism 50 includes a handle 54, plate engagement pins 56, and a bias spring 58. Plate engagement pins 56 and slam hatch 42 are at a 22½° angle, advantageously, and plate engagement pins 56 engage about one and a half inches into catch/striker plate 52, thereby promoting quick and sure engagement thereof with catch/striker plate 52. Bias spring 58 is connected to both main frame portion 40 and hatch release mechanism 50, so as to bias plate engagement pins 56 toward catch/striker plate 52 and thereby help maintain engagement therebetween.

Further associated with slam hatch 42 relative to the pivoting portion thereof adjacent frame cross member 48 is a pair of hatch cylinders 60 and a steering system support plate 62. Hatch cylinders 60 are operatively connected to both slam hatch 42 and main frame portion 40 in such a manner so as to bias slam hatch 42 into a full open position upon release of hatch release mechanism 50. Steering system 28 includes a steering wheel 64. Steering system support plate 62 interconnects steering system 28 with slam hatch 42. Thus, when slam hatch 42 is in its closed position, steering wheel 64 is at about a 45° position. Conversely, when slam hatch 42 is open, steering wheel 64 is lifted to an approximately 80° angle position. By allowing easy opening and sure closing, as well as relative movement of the steering wheel location, the design of slam hatch 42 facilitates each ingress and egress of the driver into and out of driver seat 44, while still providing for full roll cage safety.

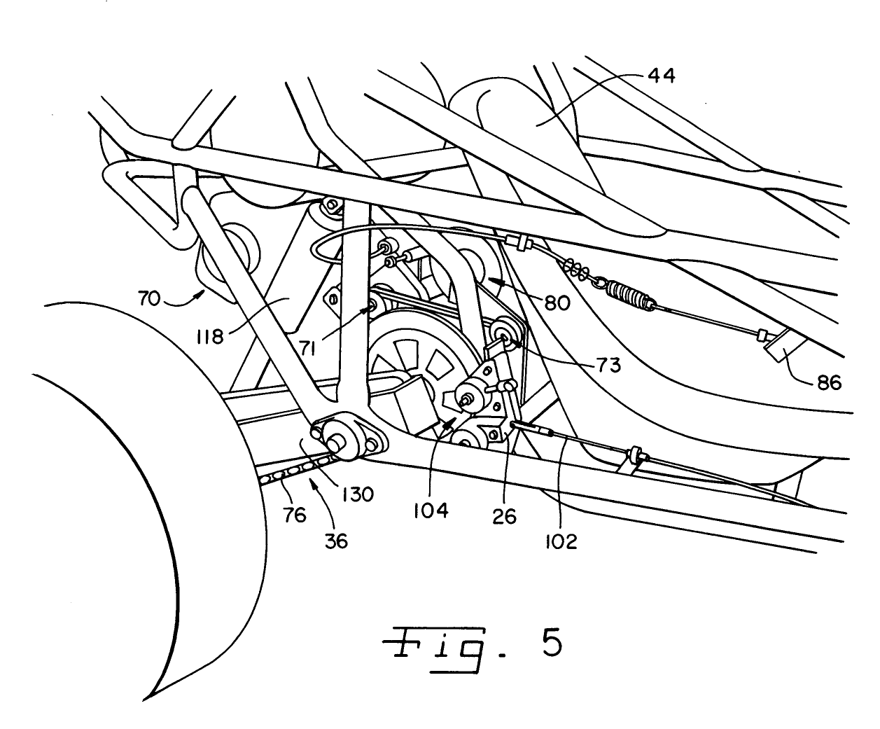

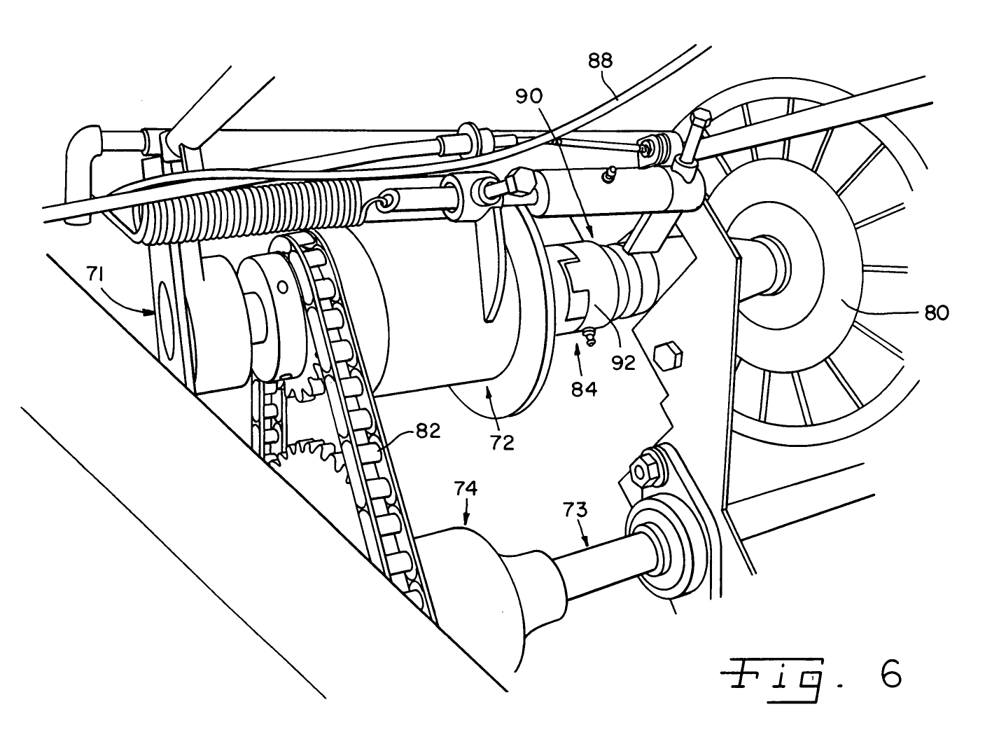

Drive train system 24, as better seen in FIGS. 5 and 6, includes an engine 70, a first or input drive shaft 71, a first differential 72, a second or output drive shaft 73, a second differential 74, and a swing-arm chain drive 76. Engine 70 advantageously can be pull-started and/or electrically started. Engine 70, for example, can be a liquid cooled twin cylinder 500 CC 100 HP Suzuki engine (max. speed of about 85 mph) or the high torque flat side 125 HP ZR 700 (top speed of about 130 mph). Associated with engine 70 is a gas tank 78 which may be a standard racing-body (e.g., NASCAR) approved tank or may be engineered from a standard air tank, thereby providing a gas tank with no sharp/square corners and safe to pressures of about 120 psi. An air-tank-based gas tank 78 is both durable and inexpensive to produce.

First drive shaft 71 and first differential 72 receive a power output from engine 70 transferred via a belt (not labeled) to a clutch 80 operatively mounted on first drive shaft 71. First differential 72 outputs power to second drive shaft 73 and, specifically, to second differential 74 carried thereon via chain output 82 (shown in FIG. 6). The presence of second differential 74 on second drive shaft 73 provides for the opportunity for one rear wheels 32 to continue to move even if the other thereof is braked or otherwise becomes stuck or unable to move.

Further associated with first differential 72 is a reverser system 84. Reverser system 84 includes a reverse lever 86 mounted on the frame 22 relative to driver seat 44, a reverse cable 88 operatively connected with reverse lever 86, a reverse actuation system 90, and a detent engagement connection 92 (i.e., a love-joy coupling) associated with first differential 72. When detent engagement connection 92 is in an engaged position, first differential 72 of drive train system 24 produces forward movement. On the other hand, when not engaged and in a released position, first differential 72 of drive train system 24 effectuates reverse movement in chain 82 and thus in shaft 73. The interaction of detent engagement connection 92 with first differential 72 potentially allows for the same speed to be achieved going in reverse as possible when moving forward. Reverse actuation system 90 is a portion of reverser system 84 that facilitates the engagement and disengagement of detent engagement connection 92. Reverser system 84 is advantageous in that it provides a very simple system to change between forward and reverse movement of sand rail 20. The intermediate location of reverser system 84 in the overall drive chain system 24 is considered a unique feature of the present invention, as it permits the avoidance of providing for a reverse gear within engine 70 and thereby permits movement as fast as reverse as provided for by the forward gearing of engine 70.

An advantage of second differential 74 is that it allows for the separate transfer of drive power to each of rear wheels 32. Second drive shaft 73 and second differential 74, which receive power input via chain output 82, outputs power separately to each of swing-arm chain drives 76 independently to each of rear wheels 32. This independent power of transfer to each of rear wheels 32 is advantageous in that it eliminates the need for rear wheels 32 to both be directly connected to a single drive shaft. Second differential 74 mounted on and coupled with drive shaft 73 permits power to continue to be transmitted to a first rear wheel 32 even if the other of rear wheels 32 is subject to braking or becomes stuck or otherwise unable to move. By not being directly connected to a single drive shaft and due to the presence of second differential 74, independent suspension of rear wheels 32, individual braking of rear wheels 32, and greater clearance over potential hazards all become possible.

The relative vertical layout of engine 70, first shaft 71, first differential 72, second shaft 73, second differential 74, and swing-arm chain drives 76 relative to one another all at the rear of sand rail 20 near the back of seat 44 help promote the compactness and size of sand rail 20 overall, as well as the efficient transfer of power between each of these elements. The compactness of drive train system 24 along with that of frame 22 permits sand rail 20 to be capable of being transported in a standard size pick-up bed, with front wheels 30 sitting in front of the wheel wells associated with the bed. That the front wheels 30 can sit in front of the wheel wells actually helps to maintain the vehicle within the pick-up.

Brake system 26, as best seen from FIGS. 1 and 5, includes brake pedals 100, brake lines 102, and disk brakes 104, there being two sets of each to permit separate braking of each of the rear wheels 32. Brake pedals 100 are spaced apart advantageously by 1 to 2 inches to allow simultaneous or separate activation thereof. Alternatively, a plate (not shown) may be provided to connect the two pedals together to ensure that both brakes are always engaged. The presence of such a plate may prove especially useful during the initial use of this vehicle.

Disk brakes 104 are mounted relative to second differential 74/drive shaft 73. By being connected to the drive shaft 73 instead of rear wheels 32, it is believed that much greater control over stopping is possible since the further transfer of power to a given rear wheel 32 is halted. Due in combination to the separate transfer of power to each of rear wheels 32 via second differential 74 and separate right and left braking, it is possible to use brake system 26 to aid in making very quick turns.

Rack-and-pinion steering system 28 is a worm-driven system that promotes easy steering, even such that it can be turned with a finger. The use of such an easily controlled steering system is unlike the hard-to-turn steering systems currently employed in other sand rails. The pivoting nature of rack-and-pinion steering system 28 actually facilitates the ability of steering wheel 64 to be mounted relative to slam hatch 42 and thereby be pivoted along with slam hatch 42 upon opening and closing thereof.

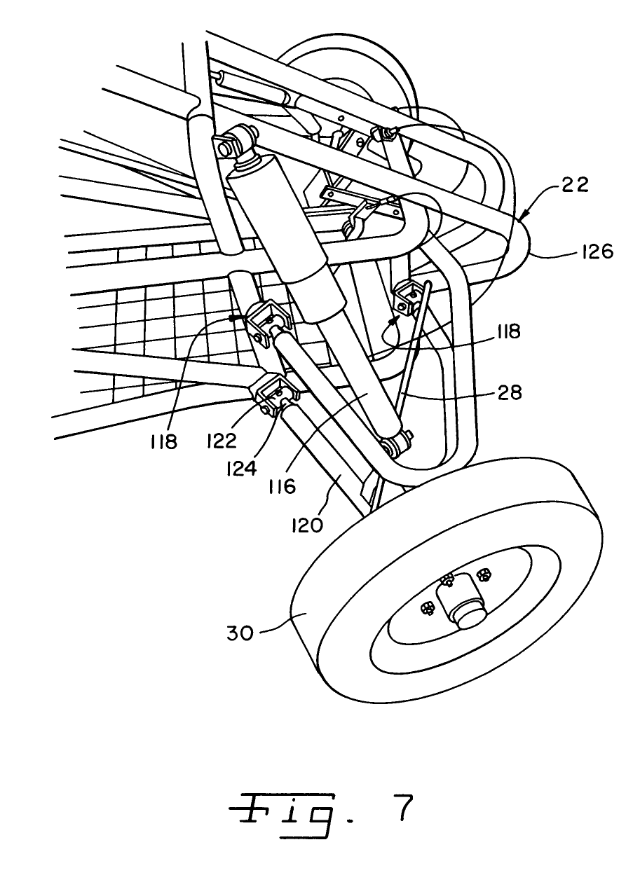

Front wheels 30 are mounted to frame 22 via respective A-frame front suspension systems 34, as best seen in FIG. 7. Each front suspension system 34 includes an upper suspension member 110, a lower suspension member 112, wheel mount plate 114, shock absorber 116, and pivotal frame interconnects 118.

Wheel mount plate 114 is pivotably connected between upper suspension member 110 and lower suspension member 112, and a respective front wheel 30 is rotatably connected thereto. Furthermore, rack-and-pinion steering system 28 is operatively connected thereto to permit turning of the respective front wheel 30.

Upper suspension member 110 and lower suspension member 112 have respective suspension member ends 120 that are connected to frame 22 via pivotal frame interconnects 118. Pivotal frame interconnects 118 each include an interconnect pivot 122 and a threaded engagement member 124. Engagement member 124 that is received into a respective suspension member end 120. The length to which each threaded engagement member 124 is inserted into a given suspension member end 120 (up to about three inches) can be used to adjust the relative positioning of each front wheel 30 relative to frame 22. Further vertical adjustment of front wheels 30 relative to frame 22 can be achieved by adjusting the amount of air in each shock absorber 116.

By adjusting shock absorbers 116 and/or threaded engagement members 124 of pivotal frame interconnects 118, sand rail 20 can be adjusted for a high ride, as preferable for off-road, and/or a low ride suitable for track racing (e.g., placing the frame as close as about an inch and a half off of the ground) and can be further separately adjusted in order to accommodate banked-track racing by changing the angle of each front wheel 30 (by adjusting relative insert lengths of engagement members 124 associated therewith) and/or the height of front wheels 30 relative to one another. Additionally, the combined effect of shock absorbers 116 and pivotal frame interconnects 118 permit each front wheel 30 to independently have about 12 to 16 inches of vertical travel associated therewith, thereby promoting a highly balanced ride for sand rail 20.

The relative horizontal positioning of front wheels 30 achieved by A-frame front suspension systems 34 is such that front wheels 30 tend to sit forward of distal forward frame end 126 of frame 22, facilitating approach of sand rail 20 onto steep inclines by not having frame 22 reach the incline prior to front wheels 30. The relative horizontal positioning of front wheels 30 with respect to distal forward frame end 126 can be adjusted by up to about four to five inches with the standard setting of the tires having them extend approximately six inches in front of distal forward frame end 126.

In order to adjust the amount of air placed in shock absorbers 116, shock absorbers 116 are connected to an air inlet valve system (not labeled) that facilitates insertion of air thereinto while allowing each shock position to be separately adjusted. As an optional feature a compressor (not shown) can be built into the system to facilitate delivery of air to shock absorbers 116.

Front wheels 30 are advantageously relatively narrow compared to rear wheels 32. By being narrower, front wheels 30 can cut a path for the driven rear wheels 32 and minimize the amount of mud/debris scattered thereby.

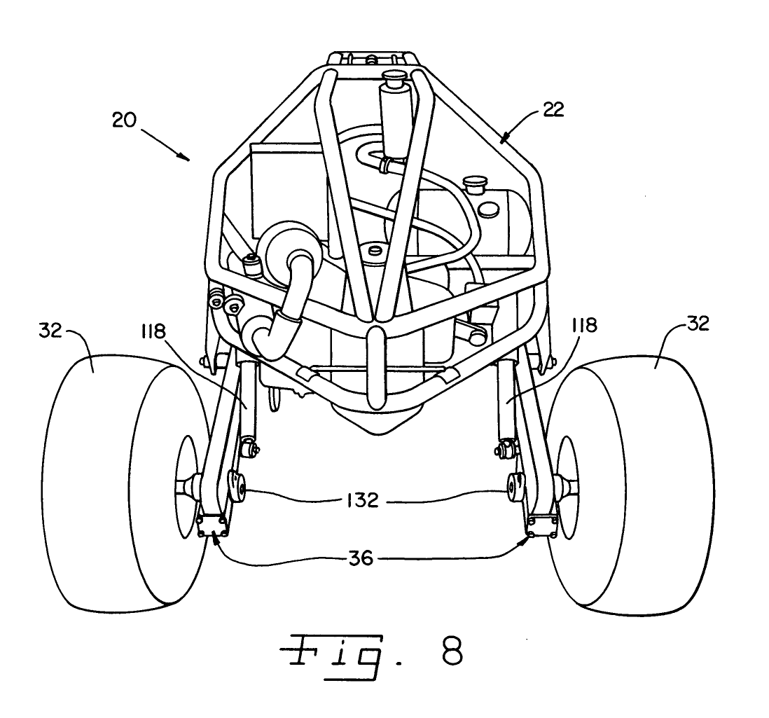

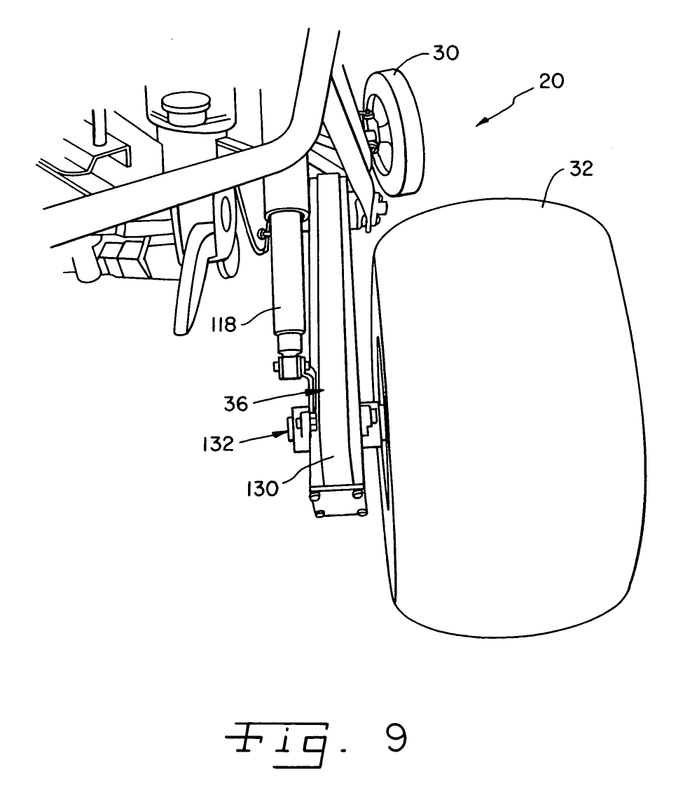

Rear suspension systems 36, each of which is associated with second shaft 73 and one of rear wheels 32, facilitates the independent suspension of rear wheels 32 and thereby together eliminate the need for a direct drive shaft connection between rear wheels 32. Each swing-arm rear suspension system 36, as best seen in FIGS. 5, 8, and 9, include a swing-arm member 130, a shock absorber 118, a swing-arm drive chain 76, and a wheel interconnect assembly 132.

Swing-arm member 130 is pivotably mounted at one end thereof to second shaft 73 and rotatably receives wheel interconnect assembly 132 at the other end thereof. Swing-arm drive chain 76 is driven by a respective end of second shaft 73 and second differential 74 and is operative relative to wheel interconnect assembly 132 for controlling the rotation of rear wheel 32 associated therewith (via a chain/sprocket system). Specifically, if the end of second shaft 73 to which swing-arm drive chain 76 is connected is one of forwardly driven, placed in reverse, and braked, swing-arm drive chain 76 will cause associated rear wheel 32 to perform likewise. Swing-arm drive chain 76, in addition to taking the form of a chain as shown, could potentially take the form of any mechanism capable of transferring rotary motion between two axles and still be in the scope of the invention.

The combination of pivotable swing-arm member 130 and shock absorber 118 for each swing-arm rear suspension system 36 permit an independent vertical travel and/or adjustment of up to about 12 to 16 inches for each of rear wheels 32, in a manner similar to that provided for front wheels 30. Likewise, the amount of air in shock absorbers 118, mounted relative to each of swing-arm members 130, can be adjusted for a range of heights, depending if sand rail 20 is to be used for off-road, track racing, or another purpose. Additionally, the relative amount of air in each of shock absorbers 118 can be adjusted so as to permit the relative vertical positioning between rear wheels 32 to be varied, e.g., to accommodate banked-track racing.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vehicle, comprising:
a frame;
an engine mounted to said frame;
an output drive shaft rotatably mounted relative to said frame, said output drive shaft being configured for selectively conveying one of forward drive power and reverse drive power to at least one wheel;
an input drive shaft rotatably mounted relative to said frame intermediate to said engine and output shaft and operatively coupled to said engine and output shaft, said input drive having an associated input drive output direction;
a first differential operatively coupled with said input drive shaft, said first differential having a pair of directional settings, a chosen said directional setting determining said input drive output direction, said directional setting being selectably one of a forward setting and a reverse setting; and
a reverser mechanism operatively associated with said first differential, said reverser mechanism being configured for selectably enacting one of said forward setting and said reverse setting of said first differential.

2. A vehicle, comprising:
a frame;
an output drive shaft rotatably mounted relative to said frame, said output drive shaft being configured for providing a drive output;
a swing-arm member pivotally mounted upon said output drive shaft, said swing-arm member including a swing-arm chain drive, said swing-arm chain drive operatively receiving said drive output of said output drive shaft; and
a wheel rotatably coupled to an end of said swing-arm member, said swing-arm chain drive configured for transferring said drive output of said output drive shaft to said wheel.

3. An off-road vehicle, comprising:
a frame including a main frame portion and a slam hatch door, said slam hatch door being selectively one of pivoted into an open position relative to said main frame portion and locked in a closed position relative thereto, said main frame portion and said slam hatch door in said closed position together defining a full roll cage for a passenger in said off-road vehicle;
at least one front wheel; and
a rack-and-pinion steering system operatively coupled with each said front wheel, said rack-and-pinion steering system including a steering wheel, said steering wheel being rotatably fixed relative to said slam hatch door, said steering wheel being concurrently relatively pivoted upon pivoting of said slam hatch door.
